(19) United States
(12) Patent Application Publication
(10) Pub. No.: US 2021/0367918 A1
(43) Pub. Date: Nov. 25, 2021

(54) USER PERCEPTIBLE INDICIA FOR WEB ADDRESS IDENTIFIERS

(71) Applicant: NVIDIA Corporation, Santa Clara, CA (US)

(72) Inventors: Amy Leigh Rose, Chapel Hill, NC (US); Benjemin Thomas Waine, Herts (GB); Andrew James Woodard, Buckinghamshire (GB); Christopher Ian Schneider, Hillend (GB)

(21) Appl. No.: 16/881,990

(22) Filed: May 22, 2020

(51) Int. Cl. H04L 29/12; H04L 29/06

(52) U.S. Cl. CPC H04L 61/60; H04L 63/20

(57) ABSTRACT

A security enhancement technique provides users of an application program with a perceptible cue, such as a visual or audible indication, that a domain and/or link is safe according to a list of safe domains/sites and links. Each identified domain and/or link is compared with domains and/or links defined in a trusted list. The trusted list is maintained by an enterprise system administrator or is provided via an internet browser program. Advantages of this technique are that the user can easily identify domain names that are trusted and does not need to examine each URL path to determine whether or not the domain and/or link is safe. Users may be motivated to scrutinize domains and/or links that are not indicated to be trusted, reducing security breaches.

### TECHNICAL FIELD

The present disclosure relates to differentiation cueing for domain names, and more particularly to providing a user with a perceptible cue for trusted domain names and links.

### BACKGROUND

Conventional techniques protecting against phishing may require a user to recognize and avoid suspicious domain names and/or links. For example, a popup may appear to prevent a user from clicking on a uniform resource locator (URL) for a known or possibly dangerous website. A padlock symbol is displayed when hypertext transfer protocol secure (HTTPS) encryption is used for the website, but HTTPS encryption no longer ensures that the website is safe because attackers are using it for malicious websites. There is a need for addressing these issues and/or other issues associated with the prior art.

### SUMMARY

Embodiments of the present disclosure implement a security enhancement technique that provides users of an application program with a perceptible cue—such as a visual or audible indication—that a web address identifier (e.g., a domain and/or hypertext link) is safe according to a list of safe domains/sites and links. Each identified web address identifier is compared with domain names and/or links defined in a trusted list. The trusted list is maintained by an enterprise administrator or is provided (entirely or in part) via an internet browser program. Advantages of this technique are that the user can easily identify domain names that are trusted and does not need to examine each domain name and/or full URL path to determine whether or not the domain and/or link is safe. Users may be motivated to scrutinize domain names and/or links that are not indicated to be trusted, reducing security breaches.

A method, computer readable medium, and system are disclosed for differentiation cueing for trusted domains. Content associated with an application program may be scanned to identify domain names. For at least one domain name that is identified in the content, the domain name is compared with a trusted list of domain names stored in memory and a user perceptible affirmative cue is provided for each domain name that matches one of the domain names included in the trusted list when the content is displayed to a user. In an embodiment, an untrusted list is used in place of or in addition to the trusted list. The untrusted list includes domains/sites and links that are deemed to be malicious, or otherwise suspected to be untrustworthy or unsafe. Domain names that match one or more entries in the untrusted list may prompt a user perceptive warning or negative cue when the content is displayed to a user.

### BRIEF DESCRIPTION OF THE DRAWINGS

FIG. 1A illustrates a conceptual diagram of applying a user perceptible cue for a trusted domain name, in accordance with an embodiment.

FIG. 1B illustrates a block diagram of a computing platform, in accordance with an embodiment.

FIG. 1C illustrates a flowchart of a method for applying a user perceptible cue, in accordance with an embodiment.

FIG. 2A illustrates a conceptual diagram of an enterprise system configured to use a trusted list, in accordance with an embodiment.

FIG. 2B illustrates a flowchart of a method for applying a user perceptible cue for a trusted web address identifier, in accordance with an embodiment.

FIG. 2C illustrates a flowchart of another method for applying a user perceptible cue, in accordance with an embodiment.

FIG. 3 illustrates a parallel processing unit, in accordance with an embodiment.

FIG. 4A illustrates a general processing cluster within the parallel processing unit of FIG. 3, in accordance with an embodiment.

FIG. 4B illustrates a memory partition unit of the parallel processing unit of FIG. 3, in accordance with an embodiment.

FIG. 5A illustrates the streaming multi-processor of FIG. 4A, in accordance with an embodiment.

FIG. 5B is a conceptual diagram of a processing system implemented using the PPU of FIG. 3, in accordance with an embodiment.

FIG. 5C illustrates an exemplary system in which the various architecture and/or functionality of the various previous embodiments may be implemented.

### DETAILED DESCRIPTION

Conventional protections against phishing and other cyberattacks may require a user to recognize and avoid suspicious domain names and/or links. For example, the domain name “microsoft.com” may be safe while “micrasoft.com” is malicious. Rather than burdening the user with the responsibility of confirming a particular domain name is safe by inspection, a perceptible cue is provided when the domain name and/or link is safe according to a trusted list.

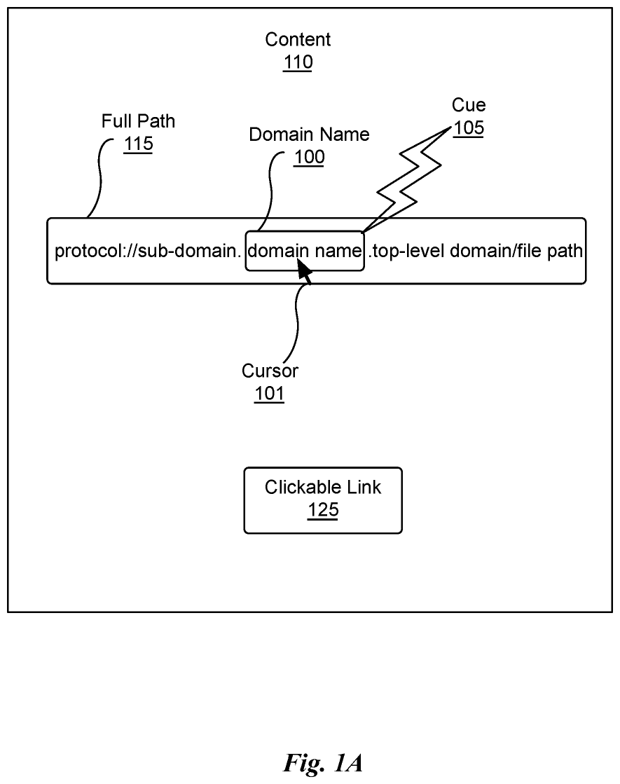

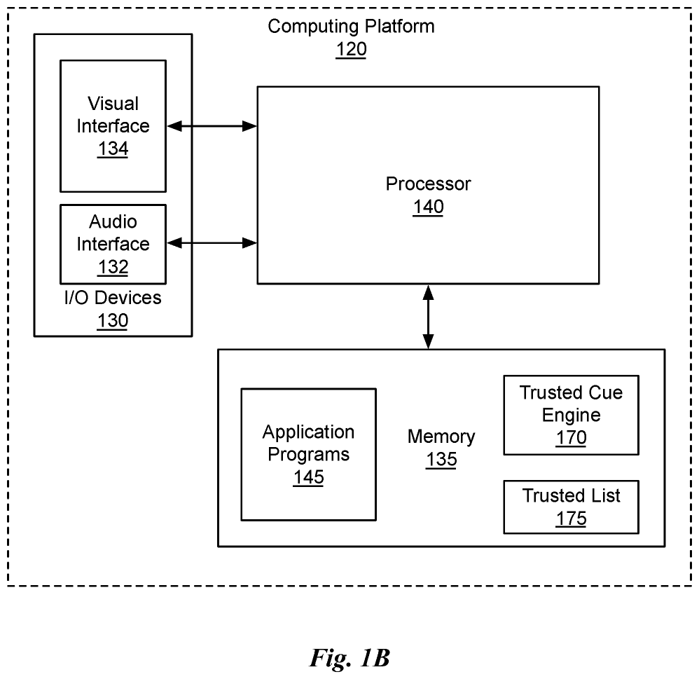

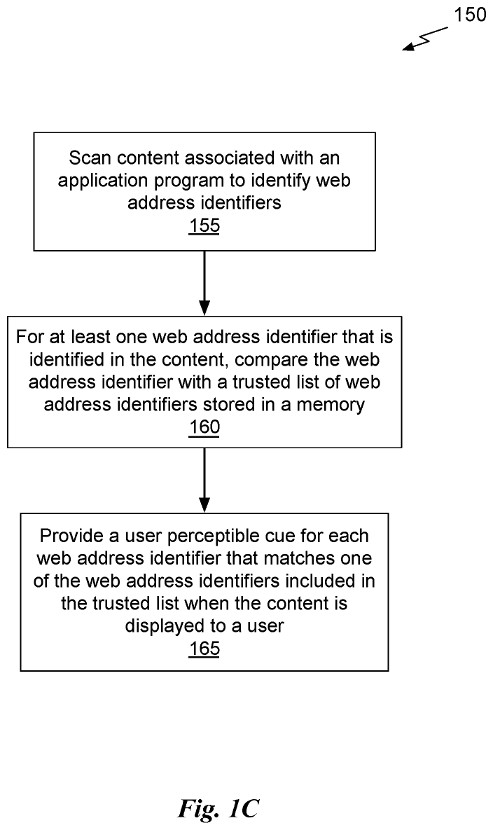

FIG. 1A illustrates a conceptual diagram of applying a user perceptible cue 105 for a domain name that is trusted, in accordance with an embodiment. During execution of an application program, content 110 that may include one or more domain names 100 is presented to a user. Example application programs that may include such content 110 include those for internet browsing, email service, calendar, and for editing and/or creating documents, content, spreadsheets, drawings and the like.

A trusted list includes one or more domain names and/or links that are deemed safe or trusted. The trusted list may include only domain names, only links, or a mix of domain names and links. The trusted list may be maintained by an enterprise system administrator or provided via an internet browser program. In an embodiment, the trusted list includes entries from a safe list provided by the internet browser program and additional domain names and/or links entered by a human enterprise system administrator. In another embodiment, the trusted list comprised only domain names and/or links maintained by a human enterprise system administrator.

Full path 115 is a URL (e.g., internet address) or link that includes several components, specifically a protocol, sub-domain, domain name 100, top-level domain, and file path. Examples of a protocol are HTTP (hypertext transfer protocol), HTTPS, and FTP (file transfer protocol). Example sub-domains are “www”. Example top-level domains are “.com”, “.gov”, and “.org”. In an embodiment, the trusted list also includes at least one full path 115 (e.g., link) that is also deemed safe or trusted. In an embodiment, a link that is included in the trusted list comprises a domain name that is also included in the trusted list. In an embodiment, the links can include wildcards for certain portions of the links, for example, a specific file path or a wild card for any file path in a specific sub-domain.

A security enhancement technique provides users of an application program with a user perceptible cue 105, such as a visual, tactile, or auditory indication, that a domain and/or link is safe according to a list of domains/sites and links that are trusted. For example, cue 105 may provide visual feedback to the user by changing the background color or pattern of a field (e.g., address bar); the font, size, or other visual indicia of the domain name 100; or at least a portion of the full path 115 included in a visual representation of content displayed on a display device by an internet browser application. In another example, the appearance (e.g., color, font, size, highlighting, etc.) of text comprising the domain name 100 or at least a portion of the full path 115 may change when the cue 105 is provided. In an embodiment, the appearance of the text or field may change as the user types characters of the domain name 100 or full path 115 into an address bar of a web browser, search engine, email application, etc. The cue 105 may be provided when a cursor 101 hovers over or within a predetermined distance of the domain name 100 or full path 115. In the context of the following description, “cursor” describes a graphical representation of a user input device overlaid on the visual representation of the content 110 displayed on a display device. In particular, a cursor location corresponds to a location within the content 110 that is determined by the user input device.

Providing the cue 105 may cause auditory feedback, such as a sound, to be generated in addition to or instead of providing visual feedback to the user. The specific auditory feedback may be predetermined or selected by the user. Providing the cue 105 may cause tactile or haptic feedback, such as a vibration, pressure, temperature change, movement, or force to be generated in addition to or instead of providing visual and/or auditory feedback to the user. The specific type of tactile feedback may be predetermined or selected by the user.

In an embodiment, instead of appearing as text, a clickable link 125 that is an image or hypertext link is displayed. In the context of the following description, a clickable link 125 and a full path 115 are both considered links. Activating the clickable link 125 by a user input device via the cursor 101, causes the website or webpage corresponding to the link to be opened. For example, an image of a company logo may be a clickable link 125 that is associated with the path of the company website homepage, such that clicking on the image causes the company website homepage to be opened. In such instances, the user may not be able to easily view the full path 115 or domain name 100 associated with the clickable link 125. However, when the domain name and/or link for the company website homepage is included in the trusted list, the cue 105 can be provided when the cursor 101 (controlled by a user input device) hovers over or within a predetermined distance of the clickable link 125. Providing the cue 105 for the clickable link 125 may take the form of visual, auditory, and/or tactile feedback. Providing the cue 105 for the clickable link 125 may cause a sound to be played in addition to or instead of changing the appearance of the clickable link 125. Providing the cue 105 for the clickable link 125 may cause tactile feedback to be generated in addition to or instead of providing visual and/or auditory feedback to the user.

In another embodiment, a threat (unsafe) list is also used instead of, or in addition to, the trusted list. The threat list comprises malicious domain names and/or links so that user perceptible warning cues can be provided to indicate that a domain and/or link is unsafe according to the threat list. In an embodiment, the user perceptible warning cues that are provided for malicious domain names and/or links are distinguishable from the user perceptible cues that are provided for trusted domain names and/or links. User perceptible cues may be provided according to both the threat list and the trusted list, only for the threat list, or only for the trusted list.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

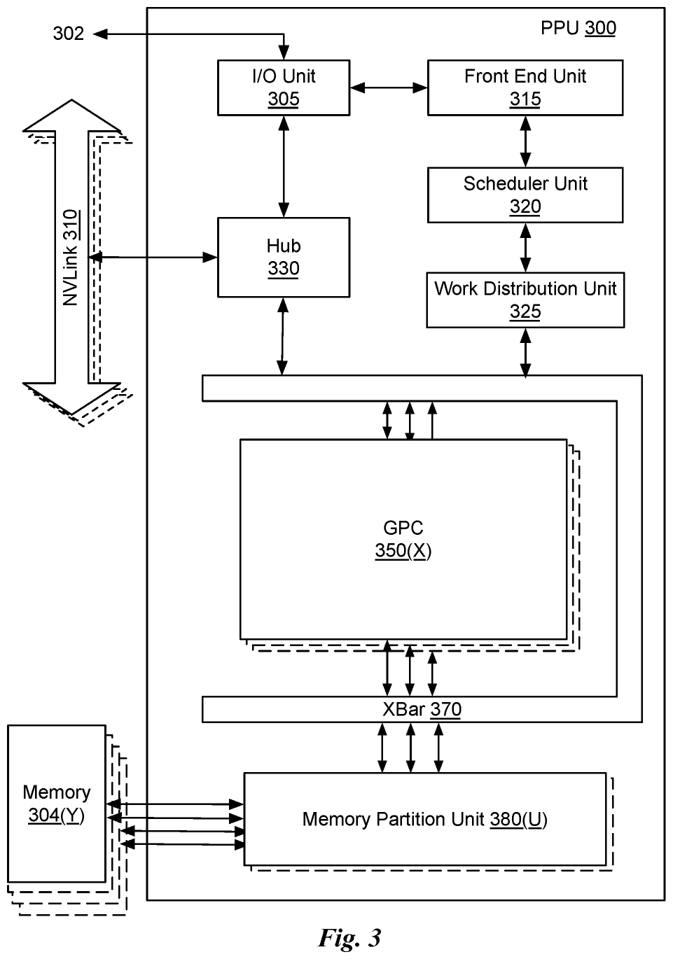

FIG. 1B illustrates a block diagram of a computing platform 120, in accordance with an embodiment. The computing platform 120 includes processor 140, I/O (input/output) devices 130, and memory 135. As depicted in FIG. 1B, a trusted cue engine 170 is stored in the memory 135. The trusted cue engine 170 can be implemented as a program (e.g., software) executed by the processor 140. Although the computing platform 120 is described in the context of processing units executing instructions, in various embodiments, the trusted cue engine 170 may be implemented as a program, custom circuitry, or by a combination of custom circuitry and a program within the computing platform 120. In an embodiment, the processor 140 is the parallel processing unit 300 shown in FIG. 3. Furthermore, persons of ordinary skill in the art will understand that any system that performs the operations of the trusted cue engine 170 is within the scope and spirit of embodiments of the present disclosure.

In some embodiments, computing platform 120 is a laptop computer, a desktop computer, a tablet computer, a communication device, a multimedia player device, a navigation or transportation device, a gaming system, or the like. The computing platform 120 may be implemented as at least a portion of a server cluster. Alternatively, the computing platform 120 may be implemented within an embedded system. In an embodiment, the computing platform 120 comprises a systems-on-chip (SoC), multi-chip module, (MCM) printed circuit board (PCB), or any other feasible implementation. The computing platform 120 may also include one or more peripheral and/or network interfaces (not shown).

In an embodiment, the memory 135 comprises high-speed random access memory, such as dynamic random access memory (DRAM) or static random access memory (SRAM). Additionally, memory 135 may include non-volatile memory, such as one or more magnetic disk storage devices, flash memory devices, optical disk storage devices, or other non-volatile storage devices. Memory 135 optionally includes one or more remotely located storage devices. Memory 135 stores application programs 145, a trusted cue engine 170, and a trusted list 175.

Trusted cue engine 170 may be implemented as a plug-in, add-in, extension, or other software component configured to generate perceptible cues for a user interface of application programs 145. The trusted list 175 includes one or more domain names and/or links that are deemed trusted or safe (e.g., free of malicious code intended to breach the security of the system accessing the code). In some embodiments, a server (remote or local) that is accessible to the computing platform 120 maintains at least a portion of the trusted list 175. The trusted list 175 may be loaded into the memory 135 from another storage resource, such as system memory, flash storage, or a network resource (e.g., from a network service or a network storage location). In an embodiment, the trusted list 175 is defined at the operating system (OS) level.

I/O devices 130 may include one or more devices configured to enable the user to receive outputs generated by the processor 140 and/or provide inputs to the processor 140. I/O devices 130 may include a visual interface 132, a visual interface 134, and one or more input devices. Visual interface 134 may be a display device, e.g. a conventional CRT (cathode ray tube), LCD (liquid crystal display), LED (light emitting diode), plasma display or the like. User input may be received from the input devices, e.g., keyboard, mouse, touchpad, microphone, and the like. In an embodiment, the visual interface 134 is a touch-screen display having a user input device integrated into the display which is configured to receive inputs via user fingers (e.g., taps and gestures) or other input devices (e.g., stylus). For a touch-screen display, a cursor is not necessarily displayed. Audio interface 134 may be speakers, headphones, and the like. In an embodiment, I/O devices 130 includes a tactile interface (not shown) that generates tactile outputs for the computing platform 120. The tactile interface may receive inputs from one or more sensors within the computing platform 120.

FIG. 1C illustrates a flowchart of a method 150 for applying a user perceptible cue 105, in accordance with an embodiment. Although method 150 is described in the context of a processor, the method 150 may also be performed by a program, custom circuitry, or by a combination of custom circuitry and a program. For example, the method 150 may be executed by a GPU (graphics processing unit), CPU (central processing unit), or any processor capable of applying a user perceptible cue 105 based on the trusted list 175. Furthermore, persons of ordinary skill in the art will understand that any system that performs method 150 is within the scope and spirit of embodiments of the present disclosure.

At step 155, content 110 associated an application program is scanned to identify web address identifiers, such as the domain name 100. The content 110 can be intended to be displayed to a user by an application program 145 via the visual interface 134. It will be appreciated that the content can be scanned prior to being displayed or subsequent to being displayed. In an embodiment, the trusted cue engine 170 is executed by processor 140 to scan the content 110. In an embodiment, the content 110 is also scanned to identify links, such as the clickable link 125, that are associated with domain names.

At step 160, for at least one domain name that is identified in the content 110, the identified domain name is compared with domain names included in the trusted list 175 that is stored in memory 135. In an embodiment, the trusted cue engine 170 compares any identified domain names with entries in the trusted list 175. In an embodiment, any identified links are also compared with links included in the trusted list 175.

At step 165, a user perceptible cue 105 is provided for each domain name that matches one of the domain names included in the trusted list 175 when the content 110 is displayed to a user. In an embodiment, the cue 105 is provided for each one of the identified domain names that matches one of the domain names included in the trusted list 175 regardless of where the cursor is located within the content 110. In another embodiment, the cue 105 is provided when the cursor 101 hovers over or within a threshold distance of an identified domain name that matches one of the domain names included in the trusted list 175. In an embodiment, a user perceptible cue 105 is provided for each link that matches one of the links included in the trusted list 175.

For example, when a domain name “NV1DIA” is displayed in a link within the content 100, the trusted cue engine 170 determines that “NV1DIA” does not match the trusted domain name “NVIDIA” and the trusted cue engine 170 will not provide the cue 105 for the domain name or generate visual, auditory, or tactile feedback. In contrast, when the domain name “NVIDIA” is displayed in a link within the content 100, the trusted cue engine 170 determines that “NVIDIA” does match the trusted domain name “NVIDIA” and the trusted cue engine 170 provides the cue 105. For example, the trusted cue engine 170 modifies the appearance of the domain name by applying the cue 105 or generates auditory, tactile, or other visual feedback.

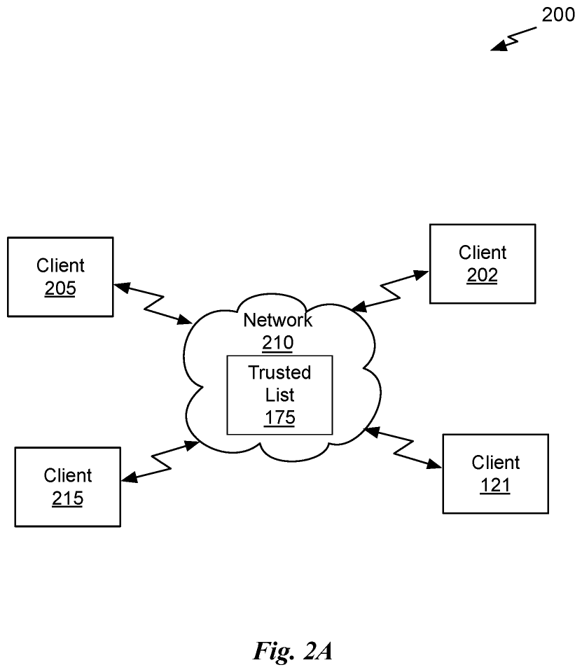

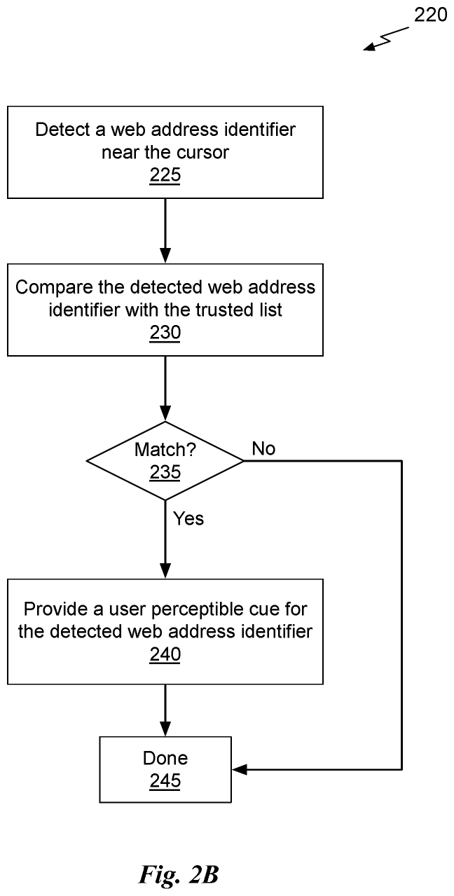

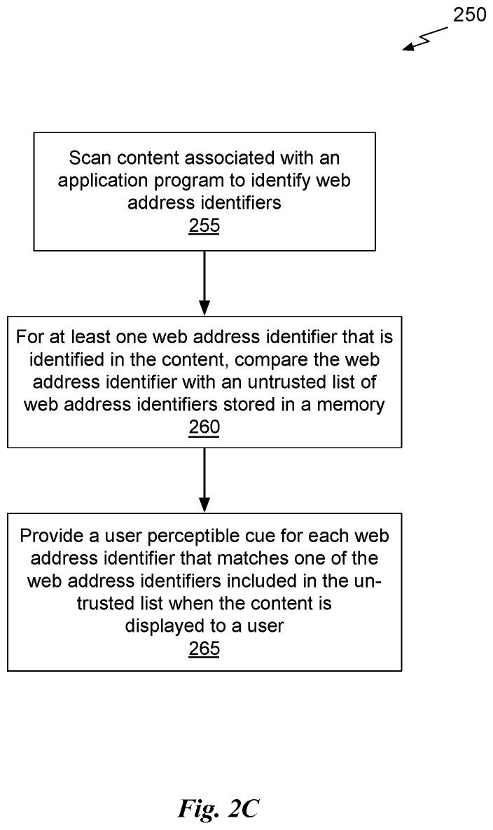

FIG. 2A illustrates a conceptual diagram of an enterprise system 200 configured to use the trusted list 175, in accordance with an embodiment. The enterprise system 200 includes one or more clients 202, 205, 212, and 215 that are configured to communicate via a network 210. One or more of the clients 202, 205, 212, and 215 may comprise the computing platform 120. Examples of the network 210 include a local area network (“LAN”), a wide area network (“WAN”), and the Internet. In an embodiment a server (not shown) that is available via the network 210 stores the trusted list 175. Each client may also store a local copy of the trusted list 175 that is coherent with the trusted list 175 stored on the server. Each client may be configured to apply user perceptible cues to content based on the trusted list 175 and according to the method 150.

In an embodiment, the server may be configured to receive requests from the clients 202, 205, 212, and 215 for reading or copying the trusted list 175 or for updating a local installation of the trusted list engine. When the trusted list 175 is changed (e.g., new domain names and/or links are removed or added), the updated trusted list 175 may be copied to each of the clients 202, 205, 212, and 215. Alternatively, each client storing a local copy of the trusted list 175 may be notified that the local copy should be synchronized with the updated trusted list 175. The trusted list 175 may be manually updated by a system administrator. In an embodiment, the trusted list 175 is automatically updated to include entries from a safe list provided by an internet browser program.

Although an enterprise environment is described, the trusted cue engine 170 may be implemented in a security application intended for consumer use. In an embodiment, the consumer may be allowed to enter domain names and/or links into the trusted list 175. In other embodiments, the consumer would not be allowed to modify the trusted list 175 and the trusted list 175 would be maintained by the security application program provider.

FIG. 2B illustrates a flowchart of a method 220 for applying a user perceptible cue for a web address identifier included in the trusted list 175, in accordance with an embodiment. Although method 220 is described in the context of a processor, the method 220 may also be performed by a program, custom circuitry, or by a combination of custom circuitry and a program. For example, the method 220 may be executed by a GPU, CPU, or any processor capable of applying cues based on a trusted list. Furthermore, persons of ordinary skill in the art will understand that any system that performs method 220 is within the scope and spirit of embodiments of the present disclosure.

At step 225, the trusted cue engine 170 detects a web address identifier located in content near (e.g., under or within a threshold distance of) the cursor that is positioned in a visual representation of the content displayed on a display device. At step 230, the trusted cue engine 170 compares the detected web address identifier with entries in the trusted list 175. At step 235, the trusted cue engine 170 determines if the detected web address identifier matches any of the entries (e.g., domain names or hyperlinks that are trusted). If a match is found, then at step 240, the trusted cue engine 170 applies a user perceptible cue in the in a visual representation of the content for the detected web address identifier before proceeding to step 245. Otherwise, if a match is not found at step 235, the trusted cue engine 170 proceeds directly to step 245 and a visual representation of the detected web address identifier that does not match one of the domain names in the trusted list is not modified. At step 245, the method terminates.

It will be appreciated that the method 220 can be repeated periodically or in response to a triggering action. For example, the method 220 can be triggered when new content is loaded by an application program 145 or in response to cursor movement or other input provided by a user (e.g., keyboard input, mouse input, or the like).

In an embodiment, an untrusted list is used in place of or in addition to the trusted list. The untrusted list includes unsafe domains/sites and links that are deemed to be malicious. In an embodiment, the untrusted list and trusted list are combined into a single list. The untrusted list may include only domain names, only links, or a mix of domain names and links. The untrusted list may be maintained by an enterprise system administrator or provided via an internet browser program. In an embodiment, the untrusted list includes entries provided by the internet browser program and additional domain names and/or links entered by a human enterprise system administrator. In another embodiment, the untrusted list comprised only domain names and/or links maintained by an enterprise system administrator.

FIG. 2C illustrates a flowchart of a method 250 for applying a user perceptible cue 105, in accordance with an embodiment. Although method 250 is described in the context of a processor, the method 250 may also be performed by a program, custom circuitry, or by a combination of custom circuitry and a program. For example, the method 250 may be executed by a GPU, CPU, or any processor capable of applying a user perceptible cue 105 based on an untrusted list. Furthermore, persons of ordinary skill in the art will understand that any system that performs method 250 is within the scope and spirit of embodiments of the present disclosure.

At step 255, content 110 associated with an application program is scanned to identify domain names, such as the domain name 100. The content 110 can be intended to be displayed to a user by an application program 145 via the visual interface 134. It will be appreciated that the content can be scanned prior to being displayed or subsequent to being displayed. In an embodiment, an untrusted cue engine is executed by processor 140 to scan the content 110. In an embodiment, the content 110 is also scanned to identify links, such as the clickable link 125, that are associated with domain names.

At step 260, for at least one domain name that is identified in the content 110, the identified domain name is compared with domain names included in the untrusted list that is stored in memory 135. In an embodiment, the untrusted cue engine compares any identified domain names with entries in the untrusted list. In an embodiment, any identified links are also compared with links included in the untrusted list.

At step 265, a user perceptible cue 105 is provided for each domain name that matches one of the domain names included in the untrusted list when the content 110 is displayed to a user. In an embodiment, a different cue 105 is provided for domain names that match an entry in the untrusted list compared with domain names that match an entry in the trusted list 175. In an embodiment, the cue 105 is provided for each one of the identified domain names that matches one of the domain names include in the untrusted list regardless of where the cursor is located within the content 110. In another embodiment, the cue 105 is provided when the cursor 101 hovers over or within a threshold distance of an identified domain name that matches one of the domain names included in the untrusted list. In an embodiment, a user perceptible cue 105 is provided for each link that matches one of the links included in the untrusted list.

For example, when a domain name “NV1DIA” is displayed in a link within the content 100, the untrusted cue engine determines that “NV1DIA” does match the untrusted domain name “NV1DIA” and the untrusted cue engine provides the cue 105 for the domain name or generate visual, auditory, or tactile feedback.

Advantages of providing a user perceptible cue for trusted domain names and/or links are that the user can easily identify the domain names and/or links that are trusted and does not need to examine at least a portion of the full URL path to determine whether or not the domain name and/or link is safe. Therefore, users may be motivated to scrutinize domain names and/or links that are not indicated to be trusted, reducing security breaches. Different user perceptible cues may be defined for untrusted domain names and/or links so that the user can easily identify and avoid the domain names and/or links that are deemed malicious.

### Parallel Processing Architecture

FIG. 3 illustrates a parallel processing unit (PPU) 300, in accordance with an embodiment. In an embodiment, the PPU 300 is a multi-threaded processor that is implemented on one or more integrated circuit devices. The PPU 300 is a latency hiding architecture designed to process many threads in parallel. A thread (e.g., a thread of execution) is an instantiation of a set of instructions configured to be executed by the PPU 300. In an embodiment, the PPU 300 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the PPU 300 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more PPUs 300 may be configured to accelerate thousands of High Performance Computing (HPC), data center, and machine learning applications. The PPU 300 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 3, the PPU 300 includes an Input/Output (I/O) unit 305, a front end unit 315, a scheduler unit 320, a work distribution unit 325, a hub 330, a crossbar (Xbar) 370, one or more general processing clusters (GPCs) 350, and one or more memory partition units 380. The PPU 300 may be connected to a host processor or other PPUs 300 via one or more high-speed NVLink 310 interconnect. The PPU 300 may be connected to a host processor or other peripheral devices via an interconnect 302. The PPU 300 may also be connected to a local memory 304 comprising a number of memory devices. In an embodiment, the local memory may comprise a number of DRAM devices. The DRAM devices may be configured as a high-bandwidth memory (HBM) subsystem, with multiple DRAM dies stacked within each device.

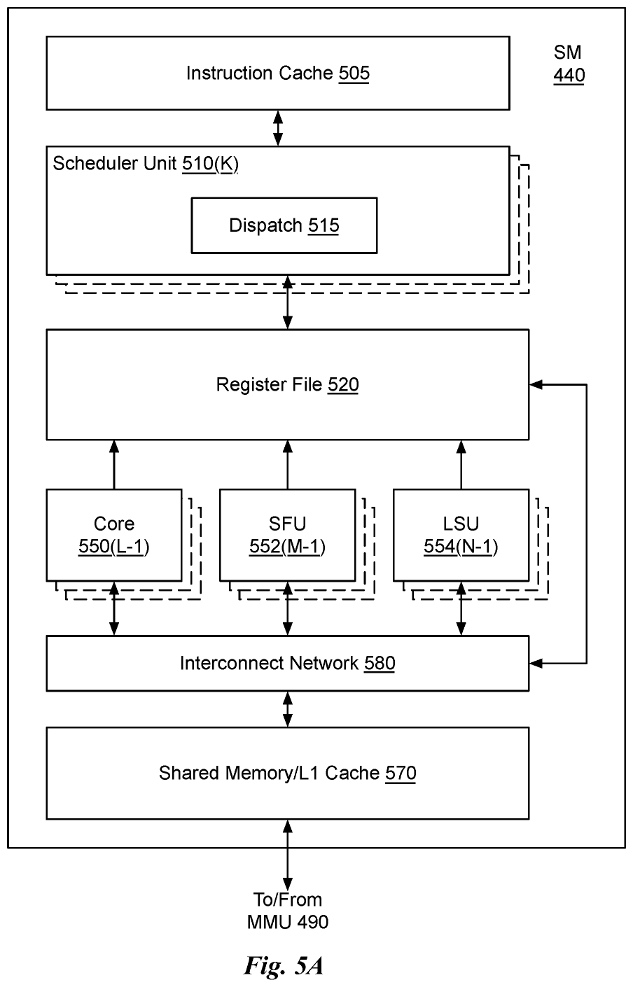

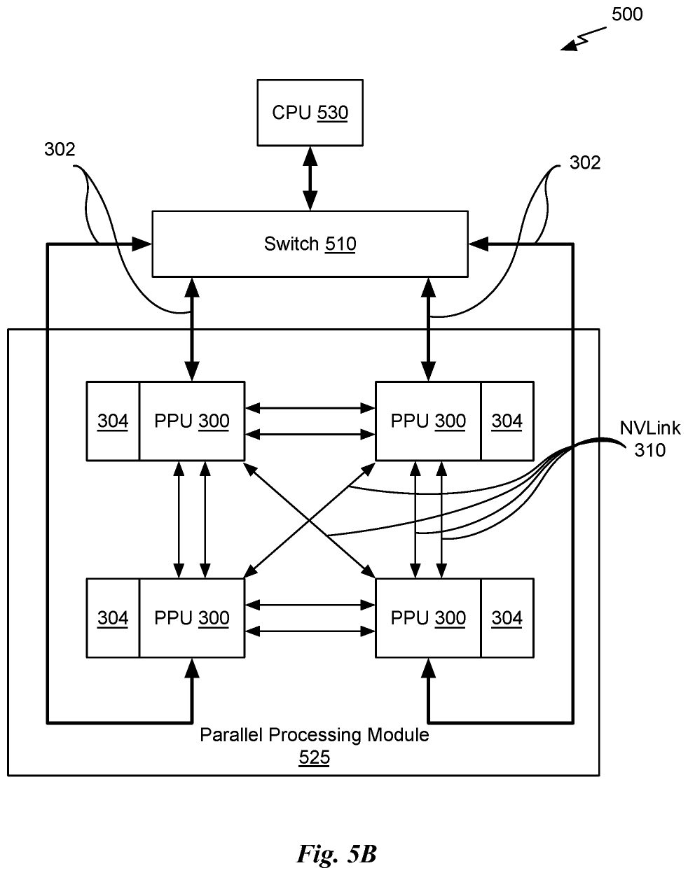

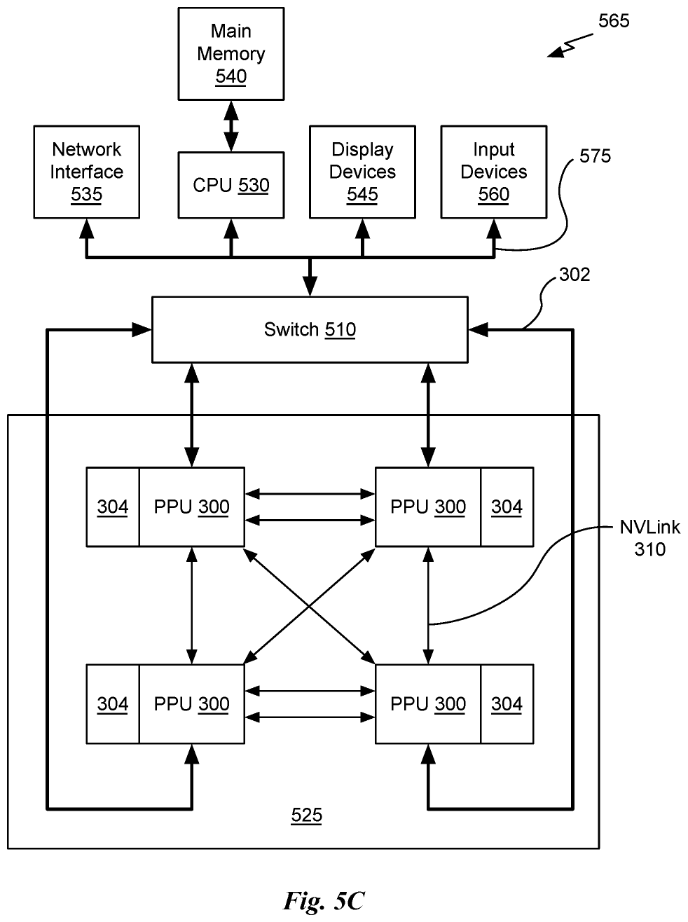

The NVLink 310 interconnect enables systems to scale and include one or more PPUs 300 combined with one or more CPUs, supports cache coherence between the PPUs 300 and CPUs, and CPU mastering. Data and/or commands may be transmitted by the NVLink 310 through the hub 330 to/from other units of the PPU 300 such as one or more copy engines, a video encoder, a video decoder, a power management unit, etc. (not explicitly shown). The NVLink 310 is described in more detail in conjunction with FIG. 5B.

The I/O unit 305 is configured to transmit and receive communications (e.g., commands, data, etc.) from a host processor (not shown) over the interconnect 302. The I/O unit 305 may communicate with the host processor directly via the interconnect 302 or through one or more intermediate devices such as a memory bridge. In an embodiment, the I/O unit 305 may communicate with one or more other processors, such as one or more the PPUs 300 via the interconnect 302. In an embodiment, the I/O unit 305 implements a Peripheral Component Interconnect Express (PCIe) interface for communications over a PCIe bus and the interconnect 302 is a PCIe bus. In alternative embodiments, the I/O unit 305 may implement other types of well-known interfaces for communicating with external devices.

The I/O unit 305 decodes packets received via the interconnect 302. In an embodiment, the packets represent commands configured to cause the PPU 300 to perform various operations. The I/O unit 305 transmits the decoded commands to various other units of the PPU 300 as the commands may specify. For example, some commands may be transmitted to the front end unit 315. Other commands may be transmitted to the hub 330 or other units of the PPU 300 such as one or more copy engines, a video encoder, a video decoder, a power management unit, etc. (not explicitly shown). In other words, the I/O unit 305 is configured to route communications between and among the various logical units of the PPU 300.

In an embodiment, a program executed by the host processor encodes a command stream in a buffer that provides workloads to the PPU 300 for processing. A workload may comprise several instructions and data to be processed by those instructions. The buffer is a region in a memory that is accessible (e.g., read/write) by both the host processor and the PPU 300. For example, the I/O unit 305 may be configured to access the buffer in a system memory connected to the interconnect 302 via memory requests transmitted over the interconnect 302. In an embodiment, the host processor writes the command stream to the buffer and then transmits a pointer to the start of the command stream to the PPU 300. The front end unit 315 receives pointers to one or more command streams. The front end unit 315 manages the one or more streams, reading commands from the streams and forwarding commands to the various units of the PPU 300.

The front end unit 315 is coupled to a scheduler unit 320 that configures the various GPCs 350 to process tasks defined by the one or more streams. The scheduler unit 320 is configured to track state information related to the various tasks managed by the scheduler unit 320. The state may indicate which GPC 350 a task is assigned to, whether the task is active or inactive, a priority level associated with the task, and so forth. The scheduler unit 320 manages the execution of a plurality of tasks on the one or more GPCs 350.

The scheduler unit 320 is coupled to a work distribution unit 325 that is configured to dispatch tasks for execution on the GPCs 350. The work distribution unit 325 may track a number of scheduled tasks received from the scheduler unit 320. In an embodiment, the work distribution unit 325 manages a pending task pool and an active task pool for each of the GPCs 350. The pending task pool may comprise a number of slots (e.g., 32 slots) that contain tasks assigned to be processed by a particular GPC 350. The active task pool may comprise a number of slots (e.g., 4 slots) for tasks that are actively being processed by the GPCs 350. As a GPC 350 finishes the execution of a task, that task is evicted from the active task pool for the GPC 350 and one of the other tasks from the pending task pool is selected and scheduled for execution on the GPC 350. If an active task has been idle on the GPC 350, such as while waiting for a data dependency to be resolved, then the active task may be evicted from the GPC 350 and returned to the pending task pool while another task in the pending task pool is selected and scheduled for execution on the GPC 350.

The work distribution unit 325 communicates with the one or more GPCs 350 via XBar 370. The XBar 370 is an interconnect network that couples many of the units of the PPU 300 to other units of the PPU 300. For example, the XBar 370 may be configured to couple the work distribution unit 325 to a particular GPC 350. Although not shown explicitly, one or more other units of the PPU 300 may also be connected to the XBar 370 via the hub 330.

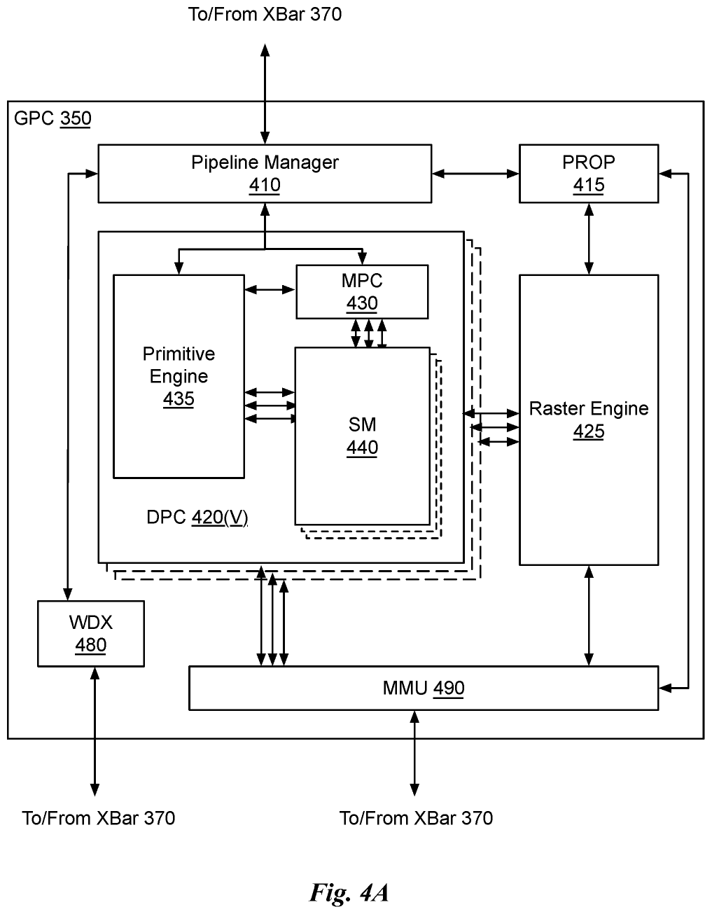

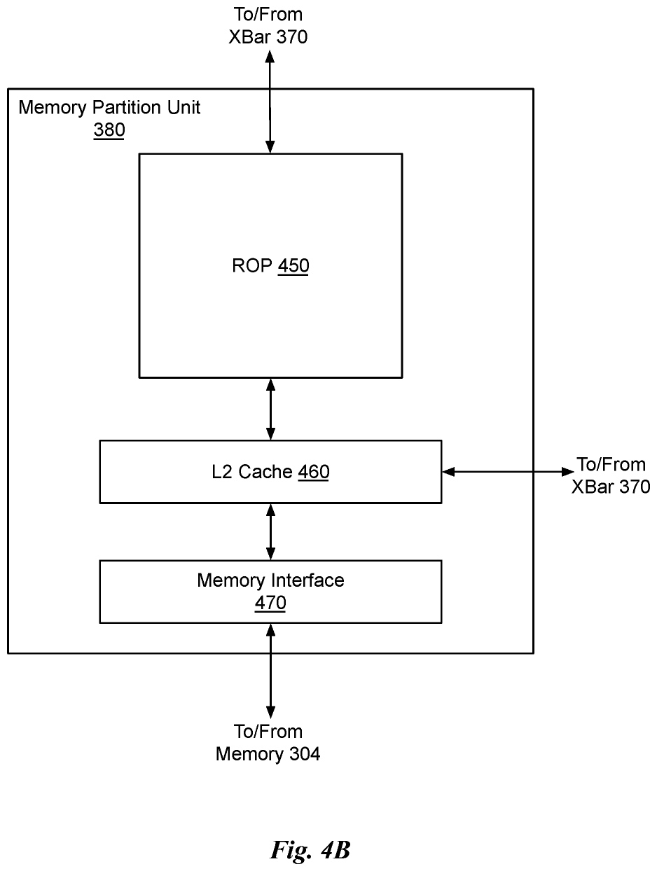

The tasks are managed by the scheduler unit 320 and dispatched to a GPC 350 by the work distribution unit 325. The GPC 350 is configured to process the task and generate results. The results may be consumed by other tasks within the GPC 350, routed to a different GPC 350 via the XBar 370, or stored in the memory 304. The results can be written to the memory 304 via the memory partition units 380, which implement a memory interface for reading and writing data to/from the memory 304. The results can be transmitted to another PPU 300 or CPU via the NVLink 310. In an embodiment, the PPU 300 includes a number U of memory partition units 380 that is equal to the number of separate and distinct memory devices of the memory 304 coupled to the PPU 300. A memory partition unit 380 will be described in more detail below in conjunction with FIG. 4B.

In an embodiment, a host processor executes a driver kernel that implements an application programming interface (API) that enables one or more applications executing on the host processor to schedule operations for execution on the PPU 300. In an embodiment, multiple compute applications are simultaneously executed by the PPU 300 and the PPU 300 provides isolation, quality of service (QoS), and independent address spaces for the multiple compute applications. An application may generate instructions (e.g., API calls) that cause the driver kernel to generate one or more tasks for execution by the PPU 300. The driver kernel outputs tasks to one or more streams being processed by the PPU 300. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 5A.

FIG. 4A illustrates a GPC 350 of the PPU 300 of FIG. 3, in accordance with an embodiment. As shown in FIG. 4A, each GPC 350 includes a number of hardware units for processing tasks. In an embodiment, each GPC 350 includes a pipeline manager 410, a pre-raster operations unit (PROP) 415, a raster engine 425, a work distribution crossbar (WDX) 480, a memory management unit (MMU) 490, and one or more Data Processing Clusters (DPCs) 420. It will be appreciated that the GPC 350 of FIG. 4A may include other hardware units in lieu of or in addition to the units shown in FIG. 4A.

In an embodiment, the operation of the GPC 350 is controlled by the pipeline manager 410. The pipeline manager 410 manages the configuration of the one or more DPCs 420 for processing tasks allocated to the GPC 350. In an embodiment, the pipeline manager 410 may configure at least one of the one or more DPCs 420 to implement at least a portion of a graphics rendering pipeline. For example, a DPC 420 may be configured to execute a vertex shader program on the programmable streaming multiprocessor (SM) 440. The pipeline manager 410 may also be configured to route packets received from the work distribution unit 325 to the appropriate logical units within the GPC 350. For example, some packets may be routed to fixed function hardware units in the PROP 415 and/or raster engine 425 while other packets may be routed to the DPCs 420 for processing by the primitive engine 435 or the SM 440. In an embodiment, the pipeline manager 410 may configure at least one of the one or more DPCs 420 to implement a neural network model and/or a computing pipeline.

The PROP unit 415 is configured to route data generated by the raster engine 425 and the DPCs 420 to a Raster Operations (ROP) unit, described in more detail in conjunction with FIG. 4B. The PROP unit 415 may also be configured to perform optimizations for color blending, organize pixel data, perform address translations, and the like.

The raster engine 425 includes a number of fixed function hardware units configured to perform various raster operations. In an embodiment, the raster engine 425 includes a setup engine, a coarse raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x,y coverage mask for a tile) for the primitive. The output of the coarse raster engine is transmitted to the culling engine where fragments associated with the primitive that fail a z-test are culled, and transmitted to a clipping engine where fragments lying outside a viewing frustum are clipped. Those fragments that survive clipping and culling may be passed to the fine raster engine to generate attributes for the pixel fragments based on the plane equations generated by the setup engine. The output of the raster engine 425 comprises fragments to be processed, for example, by a fragment shader implemented within a DPC 420.

Each DPC 420 included in the GPC 350 includes an M-Pipe Controller (MPC) 430, a primitive engine 435, and one or more SMs 440. The MPC 430 controls the operation of the DPC 420, routing packets received from the pipeline manager 410 to the appropriate units in the DPC 420. For example, packets associated with a vertex may be routed to the primitive engine 435, which is configured to fetch vertex attributes associated with the vertex from the memory 304. In contrast, packets associated with a shader program may be transmitted to the SM 440.

The SM 440 comprises a programmable streaming processor that is configured to process tasks represented by a number of threads. Each SM 440 is multi-threaded and configured to execute a plurality of threads (e.g., 32 threads) from a particular group of threads concurrently. In an embodiment, the SM 440 implements a SIMD (Single-Instruction, Multiple-Data) architecture where each thread in a group of threads (e.g., a warp) is configured to process a different set of data based on the same set of instructions. All threads in the group of threads execute the same instructions. In another embodiment, the SM 440 implements a SIMT (Single-Instruction, Multiple Thread) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The SM 440 will be described in more detail below in conjunction with FIG. 5A.

The MMU 490 provides an interface between the GPC 350 and the memory partition unit 380. The MMU 490 may provide translation of virtual addresses into physical addresses, memory protection, and arbitration of memory requests. In an embodiment, the MMU 490 provides one or more translation lookaside buffers (TLBs) for performing translation of virtual addresses into physical addresses in the memory 304.

FIG. 4B illustrates a memory partition unit 380 of the PPU 300 of FIG. 3, in accordance with an embodiment. As shown in FIG. 4B, the memory partition unit 380 includes a Raster Operations (ROP) unit 450, a level two (L2) cache 460, and a memory interface 470. The memory interface 470 is coupled to the memory 304. Memory interface 470 may implement 32, 64, 128, 1024-bit data buses, or the like, for high-speed data transfer. In an embodiment, the PPU 300 incorporates U memory interfaces 470, one memory interface 470 per pair of memory partition units 380, where each pair of memory partition units 380 is connected to a corresponding memory device of the memory 304. For example, PPU 300 may be connected to up to Y memory devices, such as high bandwidth memory stacks or graphics double-data-rate, version 5, synchronous dynamic random access memory, or other types of persistent storage.

In an embodiment, the memory interface 470 implements an HBM2 memory interface and Y equals half U. In an embodiment, the HBM2 memory stacks are located on the same physical package as the PPU 300, providing substantial power and area savings compared with conventional GDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 304 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where PPUs 300 process very large datasets and/or run applications for extended periods.

In an embodiment, the PPU 300 implements a multi-level memory hierarchy. In an embodiment, the memory partition unit 380 supports a unified memory to provide a single unified virtual address space for CPU and PPU 300 memory, enabling data sharing between virtual memory systems. In an embodiment the frequency of accesses by a PPU 300 to memory located on other processors is traced to ensure that memory pages are moved to the physical memory of the PPU 300 that is accessing the pages more frequently. In an embodiment, the NVLink 310 supports address translation services allowing the PPU 300 to directly access a CPU's page tables and providing full access to CPU memory by the PPU 300.

In an embodiment, copy engines transfer data between multiple PPUs 300 or between PPUs 300 and CPUs. The copy engines can generate page faults for addresses that are not mapped into the page tables. The memory partition unit 380 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 304 or other system memory may be fetched by the memory partition unit 380 and stored in the L2 cache 460, which is located on-chip and is shared between the various GPCs 350. As shown, each memory partition unit 380 includes a portion of the L2 cache 460 associated with a corresponding memory 304. Lower level caches may then be implemented in various units within the GPCs 350. For example, each of the SMs 440 may implement a level one (L1) cache. The L1 cache is private memory that is dedicated to a particular SM 440. Data from the L2 cache 460 may be fetched and stored in each of the L1 caches for processing in the functional units of the SMs 440. The L2 cache 460 is coupled to the memory interface 470 and the XBar 370.

The ROP unit 450 performs graphics raster operations related to pixel color, such as color compression, pixel blending, and the like. The ROP unit 450 also implements depth testing in conjunction with the raster engine 425, receiving a depth for a sample location associated with a pixel fragment from the culling engine of the raster engine 425. The depth is tested against a corresponding depth in a depth buffer for a sample location associated with the fragment. If the fragment passes the depth test for the sample location, then the ROP unit 450 updates the depth buffer and transmits a result of the depth test to the raster engine 425. It will be appreciated that the number of memory partition units 380 may be different than the number of GPCs 350 and, therefore, each ROP unit 450 may be coupled to each of the GPCs 350. The ROP unit 450 tracks packets received from the different GPCs 350 and determines which GPC 350 that a result generated by the ROP unit 450 is routed to through the Xbar 370. Although the ROP unit 450 is included within the memory partition unit 380 in FIG. 4B, in other embodiment, the ROP unit 450 may be outside of the memory partition unit 380. For example, the ROP unit 450 may reside in the GPC 350 or another unit.

FIG. 5A illustrates the streaming multi-processor 440 of FIG. 4A, in accordance with an embodiment. As shown in FIG. 5A, the SM 440 includes an instruction cache 505, one or more scheduler units 510, a register file 520, one or more processing cores 550, one or more special function units (SFUs) 552, one or more load/store units (LSUs) 554, an interconnect network 580, a shared memory/L1 cache 570.

As described above, the work distribution unit 325 dispatches tasks for execution on the GPCs 350 of the PPU 300. The tasks are allocated to a particular DPC 420 within a GPC 350 and, if the task is associated with a shader program, the task may be allocated to an SM 440. The scheduler unit 510 receives the tasks from the work distribution unit 325 and manages instruction scheduling for one or more thread blocks assigned to the SM 440. The scheduler unit 510 schedules thread blocks for execution as warps of parallel threads, where each thread block is allocated at least one warp. In an embodiment, each warp executes 32 threads. The scheduler unit 510 may manage a plurality of different thread blocks, allocating the warps to the different thread blocks and then dispatching instructions from the plurality of different cooperative groups to the various functional units (e.g., cores 550, SFUs 552, and LSUs 554) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch unit 515 is configured to transmit instructions to one or more of the functional units. In the embodiment, the scheduler unit 510 includes two dispatch units 515 that enable two different instructions from the same warp to be dispatched during each clock cycle. In alternative embodiments, each scheduler unit 510 may include a single dispatch unit 515 or additional dispatch units 515.

Each SM 440 includes a register file 520 that provides a set of registers for the functional units of the SM 440. In an embodiment, the register file 520 is divided between each of the functional units such that each functional unit is allocated a dedicated portion of the register file 520. In another embodiment, the register file 520 is divided between the different warps being executed by the SM 440. The register file 520 provides temporary storage for operands connected to the data paths of the functional units.

Each SM 440 comprises L processing cores 550. In an embodiment, the SM 440 includes a large number (e.g., 128, etc.) of distinct processing cores 550. Each core 550 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the cores 550 include 64 single-precision (32-bit) floating point cores, 64 integer cores, 32 double-precision (64-bit) floating point cores, and 8 tensor cores.

Tensor cores configured to perform matrix operations, and, in an embodiment, one or more tensor cores are included in the cores 550. In particular, the tensor cores are configured to perform deep learning matrix arithmetic, such as convolution operations for neural network training and inferencing. In an embodiment, each tensor core operates on a 4×4 matrix and performs a matrix multiply and accumulate operation D=A×B+C, where A, B, C, and D are 4×4 matrices.

In an embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each SM 440 also comprises M SFUs 552 that perform special functions (e.g., attribute evaluation, reciprocal square root, and the like). In an embodiment, the SFUs 552 may include a tree traversal unit configured to traverse a hierarchical tree data structure. In an embodiment, the SFUs 552 may include texture unit configured to perform texture map filtering operations. In an embodiment, the texture units are configured to load texture maps (e.g., a 2D array of texels) from the memory 304 and sample the texture maps to produce sampled texture values for use in shader programs executed by the SM 440. In an embodiment, the texture maps are stored in the shared memory/L1 cache 570. The texture units implement texture operations such as filtering operations using mip-maps (e.g., texture maps of varying levels of detail). In an embodiment, each SM 340 includes two texture units.

Each SM 440 also comprises NLSUs 554 that implement load and store operations between the shared memory/L1 cache 570 and the register file 520. Each SM 440 includes an interconnect network 580 that connects each of the functional units to the register file 520 and the LSU 554 to the register file 520, shared memory/L1 cache 570. In an embodiment, the interconnect network 580 is a crossbar that can be configured to connect any of the functional units to any of the registers in the register file 520 and connect the LSUs 554 to the register file and memory locations in shared memory/L1 cache 570.

The shared memory/L1 cache 570 is an array of on-chip memory that allows for data storage and communication between the SM 440 and the primitive engine 435 and between threads in the SM 440. In an embodiment, the shared memory/L1 cache 570 comprises 128 KB of storage capacity and is in the path from the SM 440 to the memory partition unit 380. The shared memory/L1 cache 570 can be used to cache reads and writes. One or more of the shared memory/L1 cache 570, L2 cache 460, and memory 304 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory/L1 cache 570 enables the shared memory/L1 cache 570 to function as a high-throughput conduit for streaming data while simultaneously providing high-bandwidth and low-latency access to frequently reused data.

When configured for general purpose parallel computation, a simpler configuration can be used compared with graphics processing. Specifically, the fixed function graphics processing units shown in FIG. 3, are bypassed, creating a much simpler programming model. In the general purpose parallel computation configuration, the work distribution unit 325 assigns and distributes blocks of threads directly to the DPCs 420. The threads in a block execute the same program, using a unique thread ID in the calculation to ensure each thread generates unique results, using the SM 440 to execute the program and perform calculations, shared memory/L1 cache 570 to communicate between threads, and the LSU 554 to read and write global memory through the shared memory/L1 cache 570 and the memory partition unit 380. When configured for general purpose parallel computation, the SM 440 can also write commands that the scheduler unit 320 can use to launch new work on the DPCs 420.

The PPU 300 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the PPU 300 is embodied on a single semiconductor substrate. In another embodiment, the PPU 300 is included in a system-on-a-chip (SoC) along with one or more other devices such as additional PPUs 300, the memory 304, a reduced instruction set computer (RISC) CPU, a memory management unit (MMU), a digital-to-analog converter (DAC), and the like.

In an embodiment, the PPU 300 may be included on a graphics card that includes one or more memory devices. The graphics card may be configured to interface with a PCIe slot on a motherboard of a desktop computer. In yet another embodiment, the PPU 300 may be an integrated graphics processing unit (iGPU) or parallel processor included in the chipset of the motherboard.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 5B is a conceptual diagram of a processing system 500 implemented using the PPU 300 of FIG. 3, in accordance with an embodiment. The exemplary system 565 may be configured to implement the method 150 shown in FIG. 1C and/or the method 220 shown in FIG. 2B. The processing system 500 includes a CPU 530, switch 510, and multiple PPUs 300, and respective memories 304. The NVLink 310 provides high-speed communication links between each of the PPUs 300. Although a particular number of NVLink 310 and interconnect 302 connections are illustrated in FIG. 5B, the number of connections to each PPU 300 and the CPU 530 may vary. The switch 510 interfaces between the interconnect 302 and the CPU 530. The PPUs 300, memories 304, and NVLinks 310 may be situated on a single semiconductor platform to form a parallel processing module 525. In an embodiment, the switch 510 supports two or more protocols to interface between various different connections and/or links.

In another embodiment (not shown), the NVLink 310 provides one or more high-speed communication links between each of the PPUs 300 and the CPU 530 and the switch 510 interfaces between the interconnect 302 and each of the PPUs 300. The PPUs 300, memories 304, and interconnect 302 may be situated on a single semiconductor platform to form a parallel processing module 525. In yet another embodiment (not shown), the interconnect 302 provides one or more communication links between each of the PPUs 300 and the CPU 530 and the switch 510 interfaces between each of the PPUs 300 using the NVLink 310 to provide one or more high-speed communication links between the PPUs 300. In another embodiment (not shown), the NVLink 310 provides one or more high-speed communication links between the PPUs 300 and the CPU 530 through the switch 510. In yet another embodiment (not shown), the interconnect 302 provides one or more communication links between each of the PPUs 300 directly. One or more of the NVLink 310 high-speed communication links may be implemented as a physical NVLink interconnect or either an on-chip or on-die interconnect using the same protocol as the NVLink 310.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 300 and/or memories 304 may be packaged devices. In an embodiment, the CPU 530, switch 510, and the parallel processing module 525 are situated on a single semiconductor platform.

In an embodiment, the signaling rate of each NVLink 310 is 20 to 25 Gigabits/second and each PPU 300 includes six NVLink 310 interfaces (as shown in FIG. 5B, five NVLink 310 interfaces are included for each PPU 300). Each NVLink 310 provides a data transfer rate of 25 Gigabytes/second in each direction, with six links providing 300 Gigabytes/second. The NVLinks 310 can be used exclusively for PPU-to-PPU communication as shown in FIG. 5B, or some combination of PPU-to-PPU and PPU-to-CPU, when the CPU 530 also includes one or more NVLink 310 interfaces.

In an embodiment, the NVLink 310 allows direct load/store/atomic access from the CPU 530 to each PPU's 300 memory 304. In an embodiment, the NVLink 310 supports coherency operations, allowing data read from the memories 304 to be stored in the cache hierarchy of the CPU 530, reducing cache access latency for the CPU 530. In an embodiment, the NVLink 310 includes support for Address Translation Services (ATS), allowing the PPU 300 to directly access page tables within the CPU 530. One or more of the NVLinks 310 may also be configured to operate in a low-power mode.

FIG. 5C illustrates an exemplary system 565 in which the various architecture and/or functionality of the various previous embodiments may be implemented. The exemplary system 565 may be configured to implement the method 150 shown in FIG. 1C and/or the method 220 shown in FIG. 2B.

As shown, a system 565 is provided including at least one central processing unit 530 that is connected to a communication bus 575. The communication bus 575 may be implemented using any suitable protocol, such as PCI (Peripheral Component Interconnect), PCI-Express, AGP (Accelerated Graphics Port), HyperTransport, or any other bus or point-to-point communication protocol(s). The system 565 also includes a main memory 540. Control logic (software) and data are stored in the main memory 540 which may take the form of random access memory (RAM).

The system 565 also includes input devices 560, the parallel processing system 525, and display devices 545, e.g. a conventional CRT (cathode ray tube), LCD (liquid crystal display), LED (light emitting diode), plasma display or the like. User input may be received from the input devices 560, e.g., keyboard, mouse, touchpad, microphone, and the like. Each of the foregoing modules and/or devices may even be situated on a single semiconductor platform to form the system 565. Alternately, the various modules may also be situated separately or in various combinations of semiconductor platforms per the desires of the user.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes.

The system 565 may also include a secondary storage (not shown). The secondary storage 610 includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 540 and/or the secondary storage. Such computer programs, when executed, enable the system 565 to perform various functions. The memory 540, the storage, and/or any other storage are possible examples of computer-readable media.

The architecture and/or functionality of the various previous figures may be implemented in the context of a general computer system, a circuit board system, a game console system dedicated for entertainment purposes, an application-specific system, and/or any other desired system. For example, the system 565 may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Machine Learning

Deep neural networks (DNNs) developed on processors, such as the PPU 300 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 300. Inferencing is less compute-intensive than training, being a latency-sensitive process where a trained neural network is applied to new inputs it has not seen before to classify images, translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 300 is a computing platform capable of delivering performance required for deep neural network-based artificial intelligence and machine learning applications.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

It should be understood that the arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. It will be recognized by those skilled in the art that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

1. A computer-implemented method comprising:
scanning content associated with an application program to identify web address identifiers included in the content before the content is displayed to a user, wherein the web address identifiers comprise one or more links that, when actuated by user input cause a website or webpage corresponding to the link to be opened;
for at least one web address identifier that is identified in the content, comparing the at least one web address identifier with a single list of web address identifiers stored in a memory, wherein the single list includes trusted web address identifiers and untrusted web address identifiers; and
displaying the content to the user, wherein the displaying comprises providing a user perceptible cue for each web address identifier that indicates a presence of each trusted web address identifier and untrusted web address identifier in the single list responsive to displaying the content to the user.

2. The computer-implemented method of claim 1, wherein the web address identifier that is identified in the content comprises a hypertext link, and wherein the single list of web address identifiers comprises at least one of one or more domain names or one or more hypertext links.

3. The computer-implemented method of claim 1, wherein providing the user perceptible cue comprises changing a pattern of a field associated with the web address identifier in a visual representation of the content.

4. The computer-implemented method of claim 1, wherein providing the user perceptible cue comprises playing a sound when a cursor is positioned over the web address identifier in a visual representation of the content.

5. The computer-implemented method of claim 1, wherein providing the user perceptible cue comprises generating haptic feedback when a cursor is positioned over the web address identifier in a visual representation of the content.

6. (canceled)

7. The computer-implemented method of claim 1, wherein providing the user perceptible warning cue comprises at least two of:
changing visual indicia of the web address identifier in a visual representation of the content;
playing a sound when a cursor is positioned over the web address identifier in a visual representation of the content; or
generating haptic feedback when a cursor is positioned over the web address identifier in a visual representation of the content.

8. The computer-implemented method of claim 1, wherein the untrusted web address identifiers are defined by a system administrator.

9. The computer-implemented method of claim 1, wherein the single list is accessed by a plugin for the application program.

10. (canceled)

11. The computer-implemented method of claim 1, wherein the trusted web address identifiers are defined by a system administrator.

12. (canceled)

13. (canceled)

14. The computer-implemented method of claim 1, wherein the application program is:
a document editing program.

15. The computer-implemented method of claim 1, wherein a visual representation of each web address identifier that does not match one of the web address identifiers in the single list is not modified.

16. A system, comprising:
a memory storing a single list of web address identifiers, wherein the single list includes trusted web address identifiers and untrusted web address identifiers; and
a processor coupled to the memory and configured to:
scan content associated with an application program to identify web address identifiers included in the content before the content is displayed to a user, wherein the web address identifiers comprise links that, when actuated by user input cause a website or webpage corresponding to the link to be opened;
for each web address identifier that is identified in the content, compare the web address identifier with the single list of web address identifiers stored in the memory;
displaying the content to the user, wherein the displaying comprises
providing a user perceptible cue for each web address identifier that indicates a presence of each trusted web address identifier and untrusted web address identifier in the single list responsive to displaying the content to the user.

17. The system of claim 16, wherein the web address identifier that is identified in the content comprises hypertext link, and wherein the single list of web address identifiers comprises at least one of one or more domain names or one or more hypertext links.

18. The system of claim 16, wherein the user perceptible cue comprises at least two of:
a modification of the visual appearance of the web address identifier in a visual representation of the content;
a sound played when a cursor is positioned over the web address identifier in a visual representation of the content;
a haptic feedback generated when a cursor is positioned over the web address identifier in a visual representation of the content.

19. (canceled)

20. (canceled)

21. The computer-implemented method of claim 1, further comprising displaying the user perceptible cue provided for each of two or more web address identifiers of the at least one web address identifier.

22. (canceled)

23. The system of claim 16, wherein the processor is further configured to provide the user perceptible cue by changing a pattern of a field associated with the web address identifier in a visual representation of the content.

24. The system of claim 16, wherein the application program is a document editing program.

25. The system of claim 16, wherein a visual representation of each web address identifier that does not match one of the web address identifiers in the single list is not modified.

26. The system of claim 16, wherein the system comprises a transportation device.

27. The system of claim 16, wherein the system comprises a gaming system.
